(19) United States
(12) Patent Application Publication
(10) Pub. No.: US 2006/0237931 A1
(43) Pub. Date: Oct. 26, 2006

(54) Combination of detachable fabric and perimeter frame for stroller

(76) Inventor: Yi-Cheng Tan, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/114,124

(22) Filed: Apr. 26, 2005

(51) Int. Cl. B62B 7/00

(52) U.S. Cl. 280/47.38

(57) ABSTRACT

A combination includes a perimeter frame mounted to a main frame of a stroller and a fabric that is coupled to the perimeter frame by at least one substantially C-shaped coupling member. The coupling member includes a first end and a hooked second end. A thumb piece projects outward from an outer face of the hooked second end of the coupling member to allow application of force. The fabric is thus easily and rapidly coupled to or disengaged from the perimeter frame.

### BACKGROUND OF THE INVENTION

1. Field of the Invention

The present invention relates to a combination of a fabric and a perimeter frame. In particular, the present invention relates to a combination of a fabric and a perimeter frame of a stroller.

2. Description of the Related Art

A stroller is a necessity for a family having a small child. A typical stroller comprises a main frame, a perimeter frame mounted to the main frame, and a fabric is coupled to the perimeter frame to define a space for accommodating a child. The fabric is roller to form a tubular portion through which the perimeter frame extends, and sewing, nailing or buckling is then carried out to fix the fabric to the perimeter frame. If the fabric is fixed to the perimeter frame by sewing or nailing, cleaning of the fabric is not easy, as it is difficult to detach the fabric from the perimeter frame. Detachment of the fabric is also difficult for the fabric mounted to the perimeter frame by buckling, as the force required for reliably maintaining the engaging relationship between the fabric and the perimeter frame while supporting the child is relatively large.

### SUMMARY OF THE INVENTION

An objective of the present invention is to provide a combination of a fabric and a perimeter frame for a stroller, in which the fabric can be easily and rapidly coupled to or detached from the perimeter frame.

The combination in accordance with the present invention comprises a perimeter frame mounted to a main frame of a stroller and a fabric that is coupled to the perimeter frame by at least one coupling member. The coupling member includes a first end and a hooked second end. A thumb piece projects outward from an outer face of the hooked second end of the coupling member to allow application of force.

In an example of the invention, the coupling member comprises a horizontal bar on the first end thereof The horizontal bar is fixed to the fabric. The hooked second end of the coupling member is releasably engaged with the perimeter frame. The hooked second end of the coupling member includes a protrusion for reliably engaging with the perimeter frame.

In another example of the invention, a buckle member is mounted on the fabric. A sleeve is securely mounted around the perimeter frame. The first end of the coupling member is pivotally mounted to the sleeve. A hook is formed on an outer face of the coupling member for releasably engaging with the buckle member. The hooked second end of the coupling member is releasably engaged with the sleeve. The hooked second end of the coupling member includes a protrusion for reliably engaging with the sleeve.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a stroller comprising a perimeter frame and a fabric in accordance with the present invention.

FIG. 2 is an exploded perspective view illustrating an example of a coupling device for the fabric and the perimeter frame in accordance with the present invention.

FIG. 3 is a perspective view illustrating coupling of the fabric and the perimeter frame in accordance with the present invention.

FIG. 4 is a perspective view illustrating the fabric and fabric device after coupling.

FIG. 5 is a perspective view illustrating another example of the coupling device for the fabric and the perimeter frame in accordance with the present invention.

### DETAILED DESCRIPTION OF THE PREFERRED EMBODIMENT

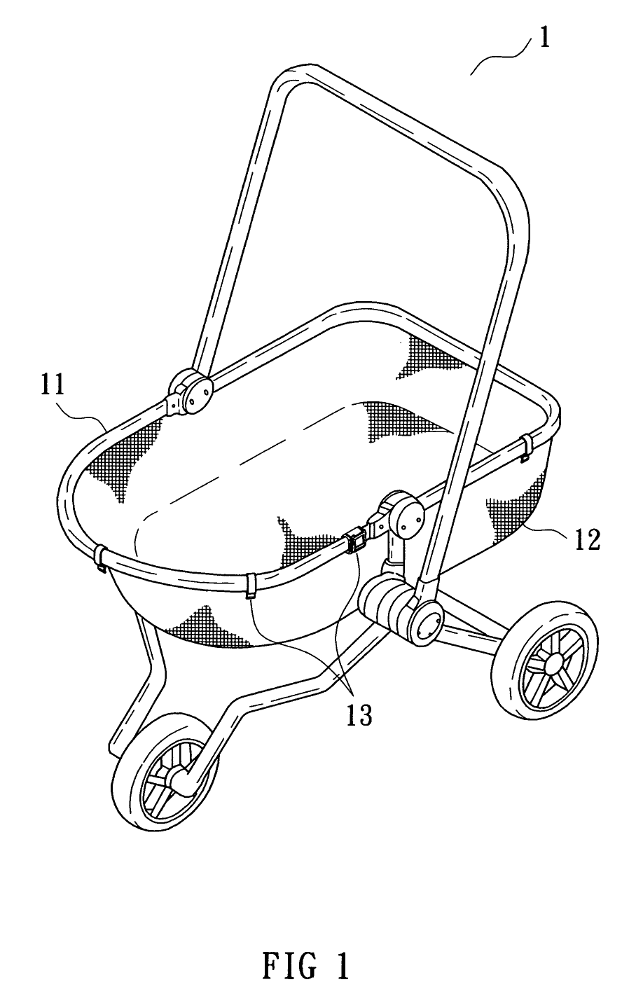

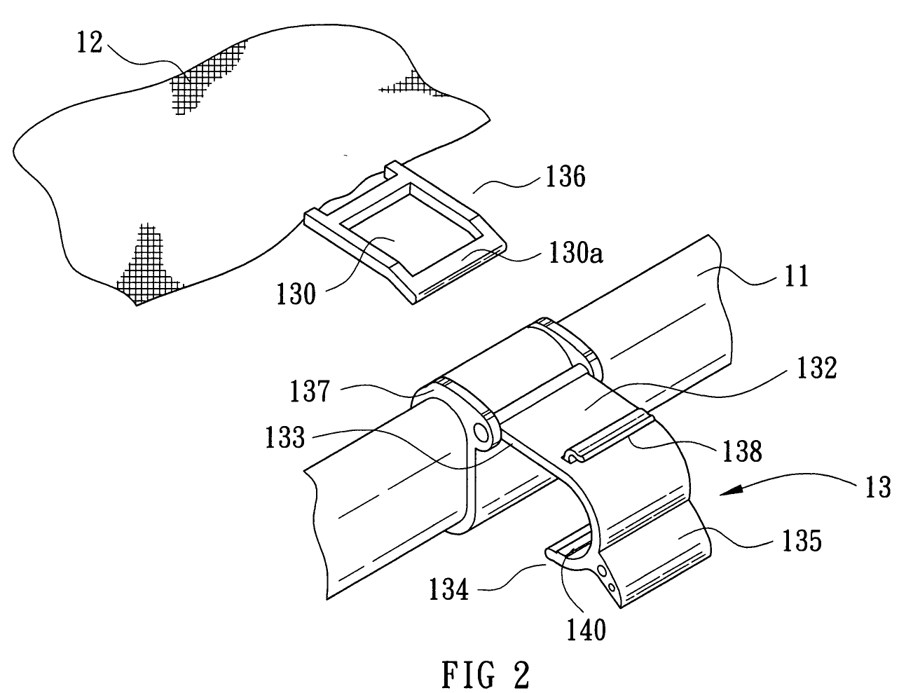

Referring to FIGS. 1 and 2, a combination of a fabric and a perimeter frame in accordance with the present invention comprises a fabric 12 and a perimeter frame 11 that is mounted to a main frame 1 of a stroller or the like. The fabric 12 is mounted to the perimeter frame 11 to form a space for accommodating a child. The fabric 12 may be made of any suitable material, including but not limited to natural fibers, synthetic fibers, and textiles.

FIG. 2 illustrates an example of a coupling device 13 for coupling the fabric 12 to the perimeter frame 11. In this embodiment, the fabric 12 includes at least one buckle member 136 fixed thereto. In an alternative embodiment, the buckle member 136 includes an end fixed to the fabric 12 via a strap (not shown). In the illustrated embodiment, the buckle member 136 includes an opening 130 to form a coupling edge 130a.

The coupling device 13 further includes at least one sleeve 137 fixed around the perimeter frame 11. The coupling device 13 further includes a substantially C-shaped coupling member 132 including a first end 133 pivotally mounted to the sleeve 137 and a substantially hooked second end 134. The coupling member 132 is resilient and sized to allow the hooked second end 134 to be securely engaged with the sleeve 137 when the coupling member 132 is pivoted to an engaged position. Preferably, the hooked second end 134 includes a protrusion 140 on an inner face thereof to provide required secure engagement between the hooked second end 134 and the sleeve 137. Further, the coupling member 132 includes a thumb piece 135 projecting outward from an outer face of the hooked second end 134 of the coupling member 132. The coupling member 132 includes a hook 138 on an outer face adjacent to the first end 133 thereof.

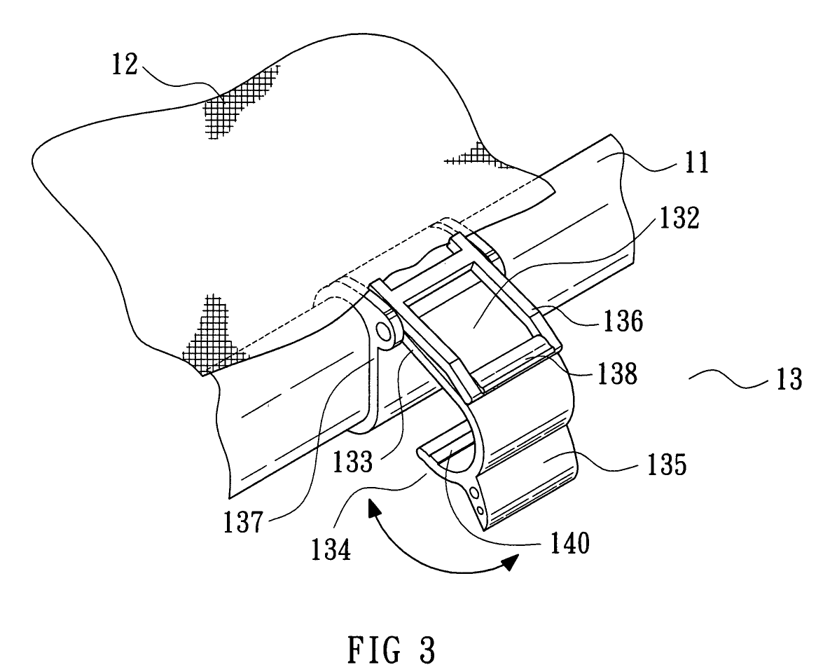

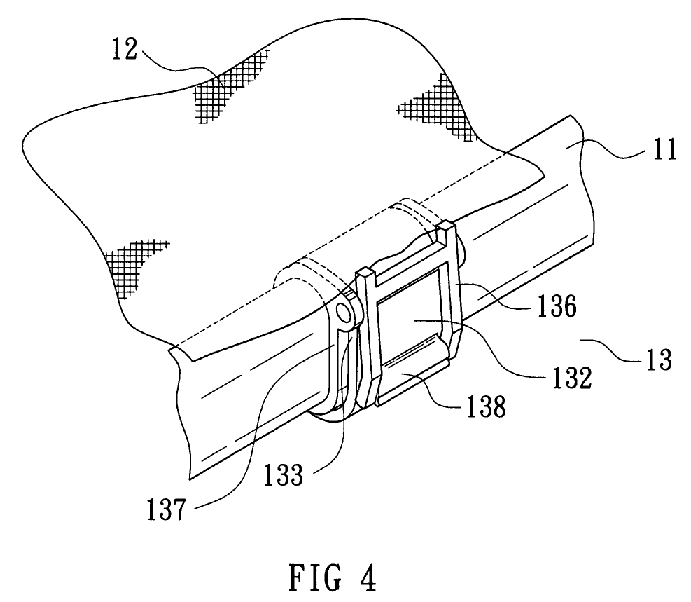

Referring to FIG. 3, when mounting the fabric 12 to the perimeter frame 11, the coupling edge 130a of the buckle member 136 is engaged with the hook 138 on the coupling member 132. Then, the coupling member 132 is pivoted from a disengaged position in FIG. 3 to an engaged position shown in FIG. 4. The hooked second end 134 of the coupling member 132 is thus securely engaged with the sleeve 137. It is noted that the user may grasp the thumb piece 135 and thus easily and rapidly fix the coupling member 132 in place with a relatively small force. Disengagement of the fabric 12 from the perimeter frame 11 can be easily and rapidly achieved in a reverse operating procedure.

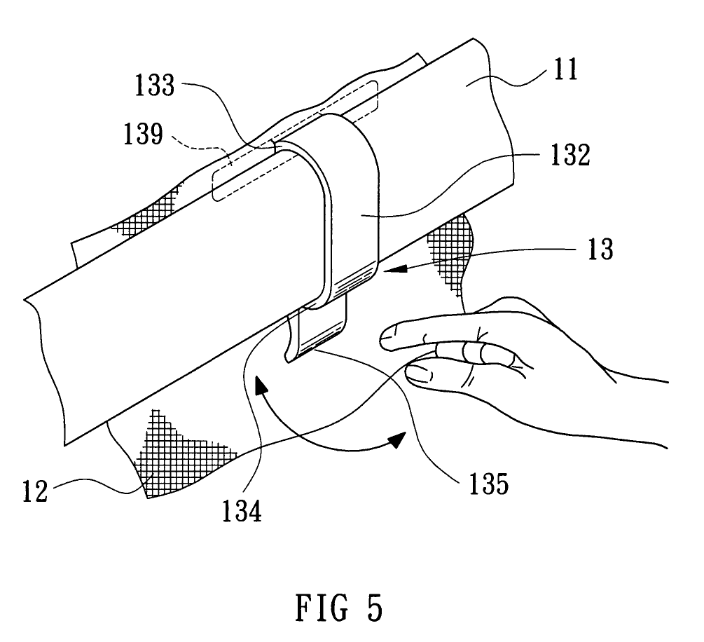

FIG. 5 illustrates another example of the coupling device, wherein at least one C-shaped coupling member 132 is fixed to the fabric 12. The coupling member 132 includes a first end to which a horizontal bar 139 is formed. The coupling member 132 further includes a hooked second end 134. The horizontal bar 139 may be fixed to the fabric 12 by sewing. When a plurality of coupling members 132 are used, the horizontal bars 139 uniformly distribute the load from the fabric 12. A thumb piece 135 projects outward from an outer face of the hooked second end 134 of the coupling member 132. Similar to the above example, a protrusion (not shown) may be provided on an inner face of the hooked second end 134 thereof to provide required secure engagement between the hooked second end 134 and the sleeve 137. This example also allows easy and rapid coupling/disengagement of the fabric 12 to/from the perimeter frame 11.

Although specific embodiments have been illustrated and described, numerous modifications and variations are still possible without departing from the essence of the invention. The scope of the invention is limited by the accompanying claims.

1. A combination of a fabric and a perimeter frame for a stroller, the combination comprising:
a perimeter frame adapted to be mounted to a main frame of the stroller; and
a fabric including at least one substantially C-shaped coupling member mounted thereto, the fabric being coupled to the perimeter frame by said at least one coupling member, said at least one coupling member including a first end and a hooked second end, said coupling member being angular& displaceable relative to the perimeter frame between first and second positions for releasable engagement therewith, a thumb piece projecting outward from an outer face of the hooked second end of said at least one coupling member to allow leveraged application of force for said coupling member angle displacement.

2. The combination of a fabric and a perimeter frame for a stroller as claimed in claim 1, with said at least one coupling member comprising a horizontal bar on the first end thereof, the horizontal bar being fixed to the fabric.

3. The combination of a fabric and a perimeter frame for a stroller as claimed in claim 2, with the hooked second end of said at least one coupling member being releasably engaged with the perimeter frame.

4. The combination of a fabric arid a perimeter frame for a stroller as claimed in claim 3, with the hooked second end of said at least one coupling member including a protrusion for reliably engaging with the perimeter frame.

5. A combination of a fabric and a perimeter frame for a stroller, the combination comprising:
a perimeter frame adapted to he mounted to a main frame of the stroller; and
a fabric including, at least one substantially C-shaped coupling member mounted thereto, the fabric being coupled to the perimeter frame by said at least one coupling member, said at least one coupling member including a first end and a hooked second end, a thumb piece projecting outward from an outer face of the hooked second end of said at least one coupling member to allow application of force,
with at least one buckle member being mounted on the fabric, further including a sleeve securely mounted around the perimeter frame, the first end of said at least one coupling member being pivotally mounted to the sleeve, a hook being formed on an outer face of said at least one coupling member for releasably engaging with said at least one buckle member.

6. The combination of a fabric and a perimeter frame for a stroller as claimed in claim 5, with the hooked second end of said at least one coupling member being releasably engaged with the sleeve.

7. The combination of a fabric and a perimeter frame for a stroller as claimed in claim 6, with the hooked second end of said at least one coupling member including a protrusion for reliably engaging with the sleeve.
